(19) United States
(12) Patent Application Publication
(10) Pub. No.: US 2016/0063068 A1
(43) Pub. Date: Mar. 3, 2016

(54) METHOD AND SYSTEM FOR CONSTRUCTING A SEARCHABLE DATABASE

(71) Applicant: YouStak, Inc., Dover, DE (US)

(72) Inventors: Michael James Dunne, Narara (AU); Robert Edmund Dunne, Labrador (AU)

(21) Appl. No.: 14/844,189

(22) Filed: Sep. 3, 2015

Related U.S. Application Data
(60) Provisional application No. 62/045,102, filed on Sep. 3, 2014.

(51) Int. Cl. G06F 17/30; G06Q 30/06

(52) U.S. Cl. CPC G06F 17/30528; G06F 17/3053; G06F 17/3056; G06F 17/30554; G06Q 30/0603; G06Q 30/0625

(57) ABSTRACT

A method of constructing a searchable database that catalogues goods or services enables an associated website to be created quickly and efficiently. The method includes: presenting to a database builder a plurality of predefined database features; receiving an identification of selected database features from the plurality of predefined database features; receiving a plurality of parameters defining the goods or services; generating a search algorithm for searching the goods or services according to the parameters; generating a graphical user interface that displays the selected database features and the plurality of parameters defining the goods or services; receiving from a user an identification of catalogued goods or services that are identified using the plurality of parameters; receiving from a user a search query that identifies desired parameters selected from the plurality of parameters defining the goods or services; and transmitting search results to a user.

### FIELD OF THE INVENTION

This invention relates generally to a method and system for constructing a searchable database, and in particular to a website for searching for goods or services.

### BACKGROUND TO THE INVENTION

Many websites exist that allow a consumer to provide a review of goods or services that the consumer has received. For example many websites exist that allow a consumer to review a restaurant. Typically such restaurant review websites allow the consumer to provide a rating for various aspects of the restaurant, such as the ambience, the quality of the food and the price.

In addition, the review website may allow a consumer to search for a suitable restaurant. The consumer may provide search parameters such as a food type and a location, and the website returns a list of restaurants that meet the search criteria. The consumer may then sort the list according to a variety of parameters including an overall rating or a location. In addition, the consumer may review comments provided by other consumers.

In order to construct a restaurant review website as described above, considerable time, cost and effort is required. Although software exists that assists in constructing some aspects of a website, such as a layout, content relating to specific goods and services are not generally created using a template. In addition, making amendments to the website generally requires a website owner to enlist the services of a website designer.

There is therefore a need for an improved method and system for constructing a searchable database.

The reference to any prior art in this specification is not, and should not be taken as, an acknowledgement or any form of suggestion that the prior art forms part of the common general knowledge in Australia or elsewhere.

### OBJECT OF THE INVENTION

It is an object, of some embodiments of the present invention, to provide consumers with improvements and advantages over the above described prior art, and/or overcome and alleviate one or more of the above described disadvantages of the prior art, and/or provide a useful commercial choice.

### SUMMARY OF THE INVENTION

In one form, although not necessarily the only or broadest form, the invention resides in a method of constructing a searchable database that catalogues goods or services, the method comprising:
presenting to a database builder a plurality of predefined database features;
receiving from the database builder an identification of selected database features from the plurality of predefined database features;
receiving from the database builder a plurality of parameters defining the goods or services;
generating a search algorithm for searching the goods or services according to the parameters;
generating a graphical user interface that displays the selected database features and the plurality of parameters defining the goods or services;
receiving from a user an identification of catalogued goods or services that are identified using the plurality of parameters;
receiving from a user a search query that identifies desired parameters selected from the plurality of parameters defining the goods or services; and
transmitting search results to a user;
wherein the search results are selected according to the search query and ranked according to a relative match between the desired parameters in the search query, and the identification of the catalogued goods or services.

In another form, the invention resides in a system for constructing a searchable database that catalogues goods or services, the system including a computing device, the computing device including a processor coupled to a memory, the memory including program code components configured to cause the processor to:
present to a database builder a plurality of predefined database features;
receive from the database builder an identification of selected database features from the plurality of predefined database features;
receive from the database builder a plurality of parameters defining the goods or services;
generate a search algorithm for searching the goods or services according to the parameters;
generate a graphical user interface that displays the selected database features and the plurality of parameters defining the goods or services;
receive from a user an identification of catalogued goods or services that are identified using the plurality of parameters;
receive from a user a search query that identifies desired parameters selected from the plurality of parameters defining the goods or services; and
transmit search results to a user;
wherein the search results are selected according to the search query and ranked according to a relative match between the desired parameters in the search query, and the identification of the catalogued goods or services.

Preferably, each desired parameter is weighted according to a parameter weighting. Preferably the parameter weighting is selected from a plurality of parameter weighting levels.

Preferably, a first user provides the identification of catalogued goods or services and a second user provides the search query that identifies desired parameters.

Preferably, the method further includes receiving a plurality of reviews associated with catalogued goods or services, wherein each review in the plurality of reviews is associated with a reviewer and includes an answer to a review question.

Preferably, the method further includes receiving from the database builder a plurality of questions defining review questions for use in reviewing catalogued goods or services.

Preferably, the search results are selected according to a review question rating provided by other users. Preferably a review question is weighted according to a review question weighting. Preferably the review question weighting is selected from a plurality of review question weightings. Preferably, each review question includes a question, a question hint and a plurality of review rating levels. A user may select a review rating level from the plurality of review rating levels. Each review rating level may include a review rating level hint.

Preferably, the search results are selected according to the search query and ranked according to a relative match between the desired parameters in the search query, the identification of the catalogued goods or services, and answers to review questions.

Preferably, the search results are selected according to a location.

Preferably, the search results are selected according to a price.

Preferably, the parameters are grouped according to one or more categories.

Preferably, the search results are analysed to determine which parameters would increase a rank of particular goods or services listed in the search results.

### BRIEF DESCRIPTION OF THE DRAWINGS

An embodiment of the invention will be described with reference to the accompanying drawings in which:

FIG. 1 illustrates a flow diagram of a method for constructing a searchable database according to an embodiment of the present invention;

FIG. 2 illustrates a block diagram of a system for constructing a searchable database according to an embodiment of the present invention;

FIG. 3 illustrates a screenshot of a setup Graphical User Interface (GUI) for constructing a searchable superhero database displayed to a database builder according to an embodiment of the present invention;

FIG. 4 illustrates a screenshot of a parameter definition GUI according to an embodiment of the present invention;

FIG. 5 illustrates a screenshot of a review question configuration GUI according to an embodiment of the present invention;

FIG. 6 illustrates a screenshot of a login GUI according to an embodiment of the present invention;

FIG. 7 illustrates a screenshot of a GUI for cataloguing goods or services according to an embodiment of the present invention;

FIG. 8 illustrates a screenshot of a search query GUI according to an embodiment of the present invention;

FIG. 9 illustrates a screenshot of a first GUI for cataloguing wineries according to an embodiment of the present invention;

FIG. 10 illustrates a screenshot of a second GUI for cataloguing wineries according to an embodiment of the present invention;

FIG. 11 illustrates a screenshot of a first winery search GUI according to an embodiment of the present invention;

FIG. 12 illustrates a screenshot of a second winery search GUI according to an embodiment of the present invention;

FIG. 13 illustrates a screenshot of a search result GUI according to an embodiment of the present invention; and

FIG. 14 diagrammatically illustrates a computing device for performing the method of the present invention, according to an embodiment of the present invention.

### DETAILED DESCRIPTION OF THE PREFERRED EMBODIMENT

Elements of the invention are illustrated in concise outline form in the drawings, showing only those specific details that are necessary to understanding the embodiments of the present invention, but so as not to clutter the disclosure with excessive detail that will be obvious to those of ordinary skill in the art in light of the present description.

In this patent specification, adjectives such as first and second, left and right, front and back, top and bottom, etc., are used solely to define one element from another element without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention. It will be appreciated that the invention may be implemented in a variety of ways, and that this description is given by way of example only.

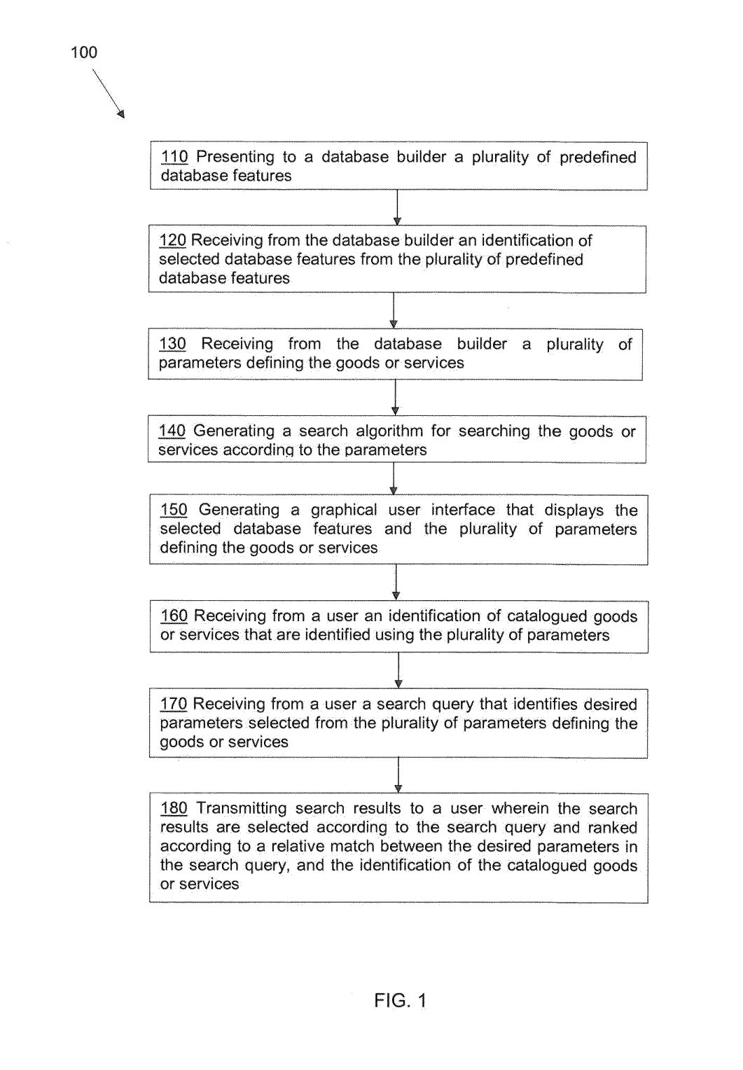

FIG. 1 illustrates a block diagram of a method 100 of constructing a searchable database that catalogues goods or services. At step 110 a plurality of predefined database features are presented to a database builder. The database features may include a look and feel of a Graphical User Interface (GUI) of the searchable database. At step 120, an identification of selected database features from the plurality of predefined database features are received from the database builder. At step 130 a plurality of parameters defining the goods or services are received from the database builder. The parameters describe aspects of the goods or services, such as physical characteristics, quality levels, price, location, colours, advantages, etc. At step 140, a search algorithm is generated for searching the goods or services according to the parameters. At step 150, a graphical user interface is generated that displays the selected database features and the plurality of parameters defining the goods or services. At step 160, an identification of catalogued goods or services, that are identified using the plurality of parameters, are received from a user. For example a user may catalogue an Indian restaurant, and thus the user chooses an Indian food type parameter. At step 170, a search query, that identifies desired parameters selected from the plurality of parameters defining the goods or services, is received from a user, where this user is generally different from the user who provided the identification of the catalogued goods or services. For example a second user may search the database for an Indian restaurant. At step 180, search results are transmitted to the user, wherein the search results are selected according to the search query and ranked according to a relative match between the desired parameters in the search term, and the identification of the catalogued goods or services. For example a database of restaurants is searched and identifications of all catalogued Indian restaurants that meet the user's search query are displayed.

An advantage of the present invention is that websites for goods and services may be created quickly and efficiently, with a minimum level of technical know-how, and at a reduced cost to the database builder. Furthermore, the websites can be effectively searched based on specific parameters of interest to users, and ranked searched results provided based on a level of matching between an identification of catalogued goods or services and parameters defined in a search query. Further, the ranked search results can be based on review ratings provided by other users (e.g., individual users or classifications of users) who are explicitly trusted by the user conducting the search.

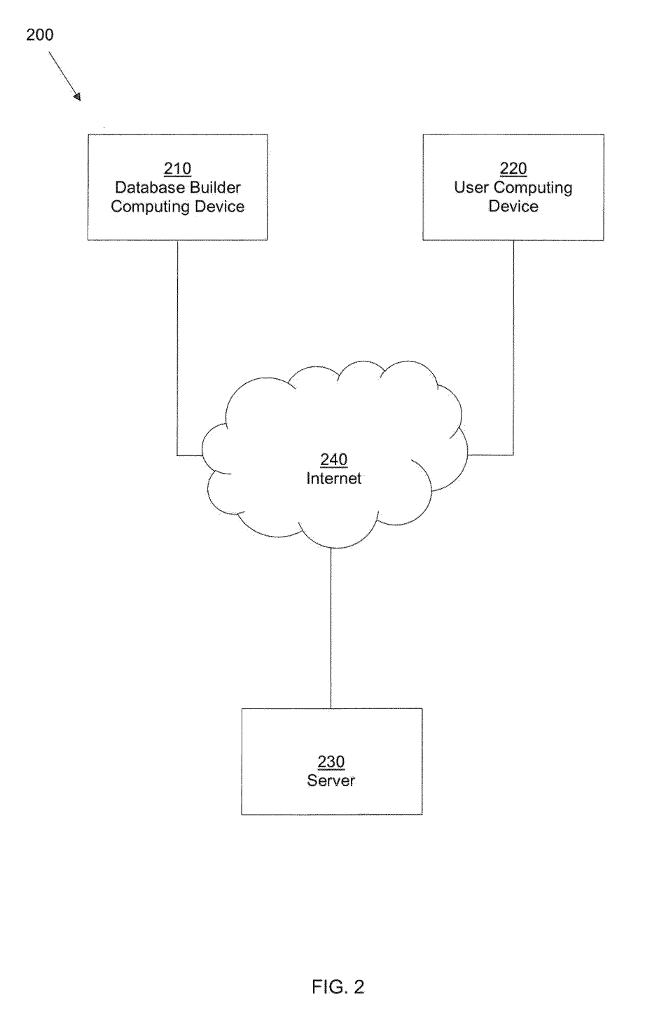

FIG. 2 illustrates a block diagram of a system for constructing a searchable database according to an embodiment of the present invention. The searchable database is constructed by a database builder using a database builder computing device 210. In some embodiments, the searchable database may be stored on a server 230 for performing online searches via the Internet 240 or any other suitable computer network. Once the searchable database has been constructed, a user, using a user computing device 220, may search for goods or services by identifying desired parameters, and goods or services that match the user's desired parameters are returned by the server 230. Although the invention may be implemented using the system of FIG. 2, it should be appreciated that the invention alternatively may be implemented on a stand-alone computing device, or using any distributed computing network.

It should be appreciated that the present invention may be used to construct databases for any suitable application, such as for advertising goods or services for sale. Such goods or services can encompass, for example, personal products, business products, real estate, restaurants, professional services, trade services, etc. Alternatively, the goods or services may be associated with interests such as collectables, hobbies, clubs and associations, and the websites assist users to interact concerning shared interests. Thus searchable databases may concern, for example, restaurants, wineries, cars, hairdressers, astronomy, or auto mechanics, to name but a few.

As one example, a database can be constructed to enable users to share information about superheros. Thus such a database could be of interest to collectors of superhero figurines, sellers of superhero costumes or superhero comic books, or to people who are simply interested in superhero facts and trivia.

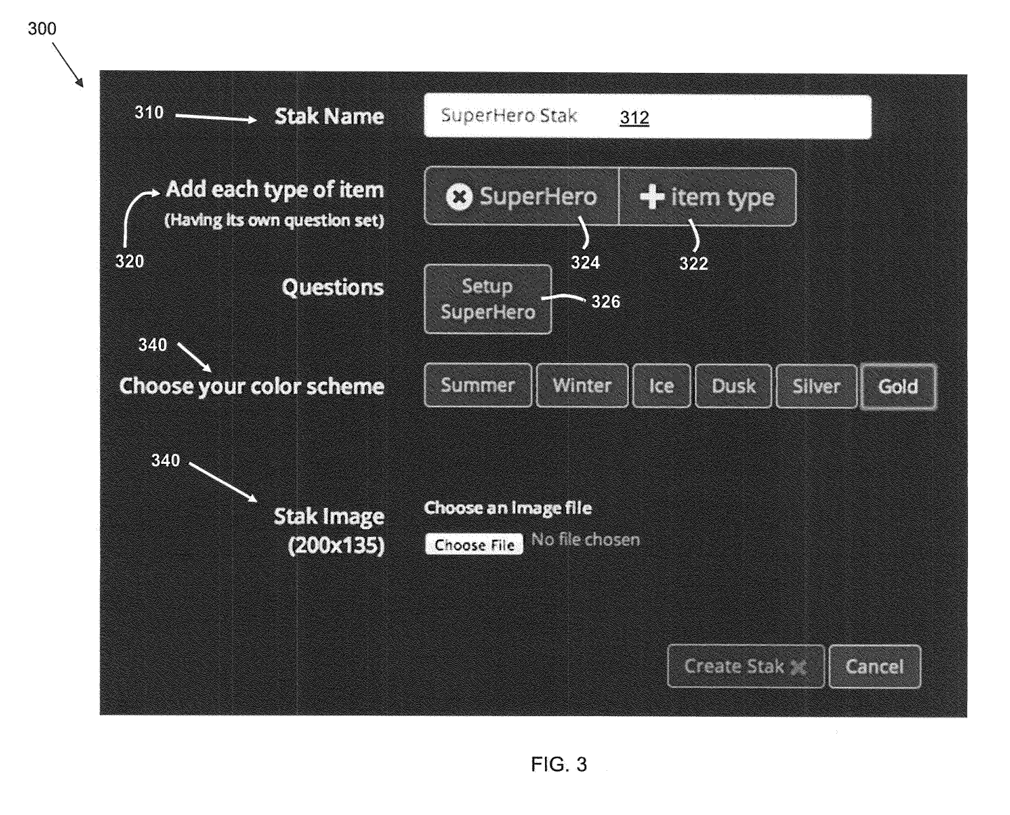

To build a superhero database, a database builder first constructs the database in which other users can catalogue various superhero goods or services. For example, once constructed, other users may catalogue superhero figurines or simply facts about superheros such as superman, batman and wonder woman. The embodiments described with reference to FIGS. 3-8 describe a searchable database of superheros. However it should be appreciated that other searchable databases may be constructed in a similar manner.

FIG. 3 illustrates a screenshot 300 of a setup Graphical User Interface for constructing a searchable superhero database displayed to a database builder according to an embodiment of the present invention. The database may be in the form of a website which, once designed, may be displayed to a user. The database builder constructs the database via a series of GUIs which are presented to the database builder at the database builder computing device 210.

The setup GUI includes a plurality of predefined database features from which the database builder may select. For example, database features may include a database name 310, a database type 320, a colour theme 330 and a database image 340. However, it should be appreciated that the predefined database features may include any other suitable features, such as a look and feel of the database or website.

The database builder may enter a database name 310 in a database name field 312. In the present embodiment, the database, or as referred to in the figures a “stak”, relates to superheros. Thus a suitable database name entered into the database name field 312, may be “SuperHero stak”.

The database builder may specify a type 320 of goods or services, by clicking on an add type button 322. In this example, the database builder has added a superhero type 324, for constructing the database of superheros. In addition, the database builder may select a desired colour theme 330, and a database image by clicking on a database image button 340 and selecting a desired image. The image may relate to the type of product or service to which the database relates. In the present example, the image may show a picture of one or more superheros.

Once the database builder has specified a type of the goods or services, the database builder may specify one or more parameters defining the goods or services. Parameters define characteristics of the goods and services. For example, a database of cars may include parameters such as an engine size, a 0-100 km/hr time, and a number of passenger seats.

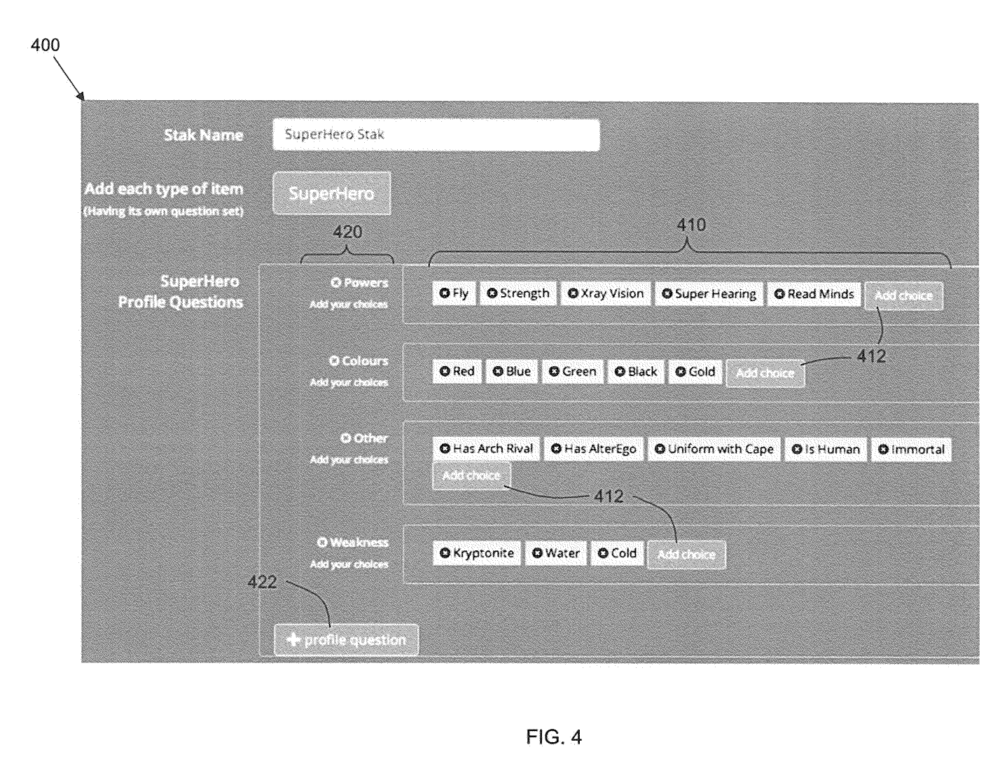

FIG. 4 illustrates a screenshot 400 of a parameter definition GUI according to an embodiment of the present invention. As shown in FIG. 4, in some embodiments, parameters 410 are grouped into categories 420 or, as shown in FIG. 4, categories 420 are referred to as a “profile questions”. A category 420 may be added to the searchable database by clicking on an add category button 422 and entering a description of the category into a text field.

Once a category 420 has been created, one or more parameters 410 may be added to a category 420 by clicking on an add parameter button 412 and entering a description of a parameter into a text field. Although the parameters 410 have been grouped into categories 420, it should be appreciated that grouping the parameters 410 is for the user's convenience, and the parameters 410 may not be grouped.

In the embodiment shown in FIG. 4, exemplary categories for superheros may be “powers”, “colours”, “weaknesses” and “other”. As shown in FIG. 4 exemplary powers may include that the superhero can fly, the superhero has strength, the superhero has x-ray vision, the superhero has super hearing and/or that the superhero can read minds. Similarly exemplary colours related to the superhero may be red, blue, green, black and/or gold. In addition exemplary weaknesses may be that the superhero has a reaction to kryptonite, water and/or the cold.

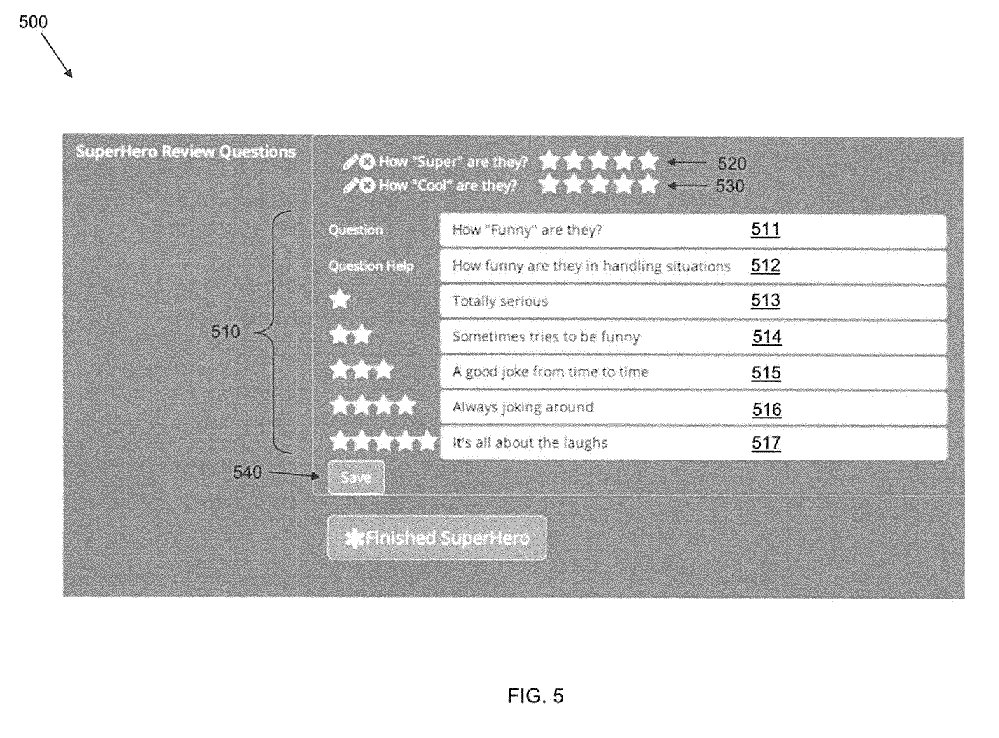

Once the parameters have been defined for the goods or services, the database builder may configure a number of review questions. FIG. 5 illustrates a screenshot 500 of a review question configuration GUI according to an embodiment of the present invention. Although FIG. 5 shows 3 review questions 510, 520, 530, it should be appreciated that any number of review questions may be configured, and each review question 510, 520, 530 is configured in a similar manner.

A first review question 510 is configured by the database builder by entering a question into a question field 511, and entering a question hint into a question hint field 512. In the superheros embodiment shown in FIG. 5, a suitable question may be “How funny are they?”. In addition, the question may include a hint as to the context of the question. Thus a suitable question hint may be “How funny are they in handling situations?”.

The first review question 510 may include a number of pre-defined review rating levels. In the embodiment shown in FIG. 5, each review rating level includes a star rating, from 1 star to 5 stars, with 1 star being a lowest rating and 5 stars being a highest rating. Each review rating level may include a review rating hint to assist the user in deciding a review rating level. Although a star rating is described, it should be appreciated that any suitable rating scheme may be used.

A first review rating level includes a first review rating hint which is entered into a first review rating hint field 513. A second review rating level includes a second review rating hint which is entered into a second review rating hint field 514. A third review rating level includes a third review rating hint which is entered into a third review rating hint field 515. A fourth review rating level includes a fourth review rating hint which is entered into a fourth review rating hint field 516. Finally, a fifth review rating level includes a fifth review rating hint which is entered into a fifth review rating hint field 517. Each review rating hint describes a respective review rating level, to aid the user when providing a review rating. For example, a suitable first review rating hint can be “Totally serious”, a suitable second review rating hint may be “Sometimes tries to be funny”, a suitable third review rating hint may be “A good joke from time to time”, a suitable fourth review rating may be “Always joking around”, and a suitable fifth review rating hint may be “It's all about the laughs”.

Once the database builder has designed the searchable database of goods or services, users may catalogue specific goods or services in the database of goods or services. For example, the user may add a superhero to a database of superheros via a suitable GUI displayed on the user's computing device 220.

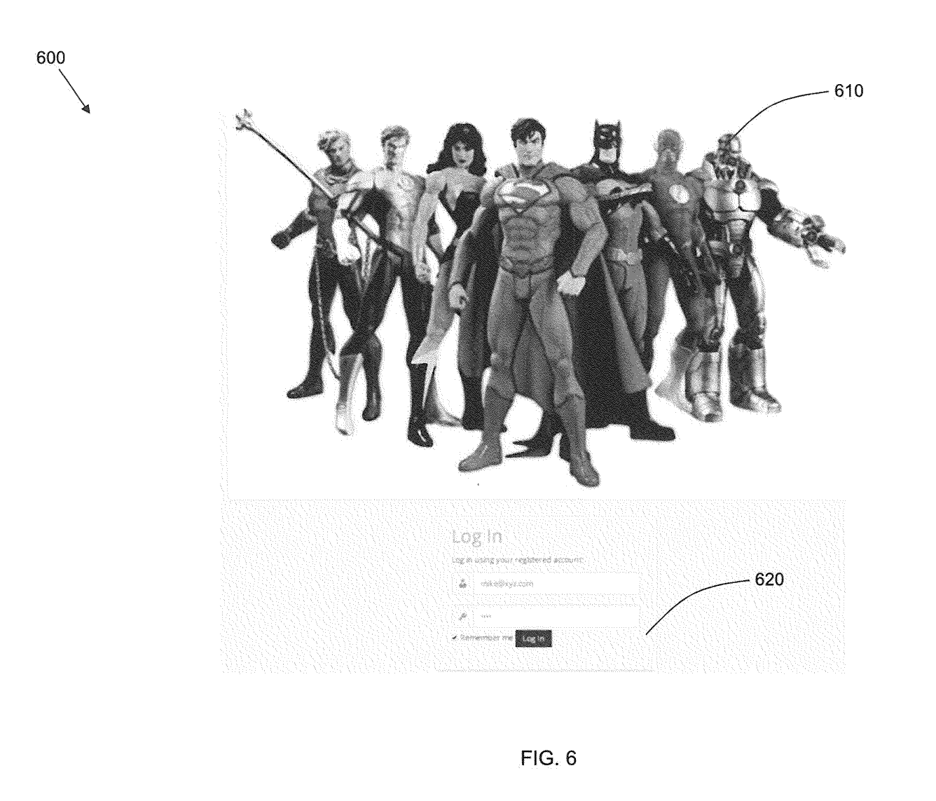

In order to catalogue goods or services in the database of goods or services, a user may be required to log in. FIG. 6 illustrates a screenshot 600 of a login GUI according to an embodiment of the present invention. As shown in FIG. 6, the login page includes an image 610, which was selected by the database builder in FIG. 3, and login fields 620. The login fields 620 may include a username and password to enable the user to log in.

Once logged in, the user may catalogue goods or services into the database of goods or services. For example, Superman may be catalogued into the database of superheros. Other superheros such as spiderman, wonder woman, batman, robin, and the joker, may be catalogued in a similar manner.

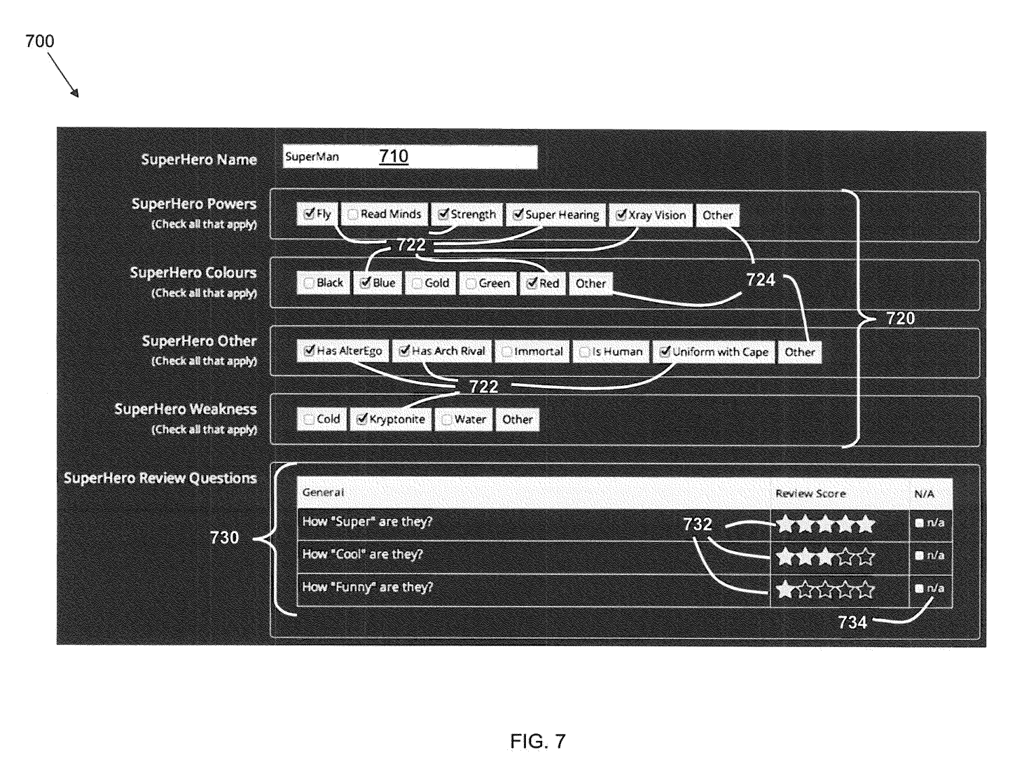

FIG. 7 illustrates a screenshot 700 of a GUI for cataloguing goods or services according to an embodiment of the present invention. For each of the goods or services to be catalogued, a user may enter a name 710 of the goods or services, for example, “superman”. In many cases, the user cataloguing the goods and services will be different from and independent of the user who created the database. Thus for example a user who catalogues goods and services may be a member of the public who accesses the database through a publicly available website.

The user cataloguing goods or services may provide an identification 722 of the goods or services. The goods or services are identified using the plurality of parameters 720 which relate to the goods or services being catalogued. In particular, the user may identify parameters from the plurality of parameters which were entered by the database builder, by clicking on an identified parameter 720. In addition, the user may enter other parameters not listed by clicking on an other button 722, and entering a suitable description of a parameter.

In addition, the user may provide a review rating 732 by rating each of the review questions 730 set by the database builder in FIG. 5. However it should be appreciated that the user may also provide a rating for other goods or services in the database entered by other users without cataloguing a good or a service.

As shown in FIG. 7, the review rating 732 for each of the review questions 730 is provided by a user selecting a number of stars out of a maximum of 5 stars. However it should be appreciated that the rating 732 may be provided using any suitable system such as, but not limited to, a percentage, or a number out of 5 or 10. In addition, the user may not provide a rating by selecting a not applicable box 734.

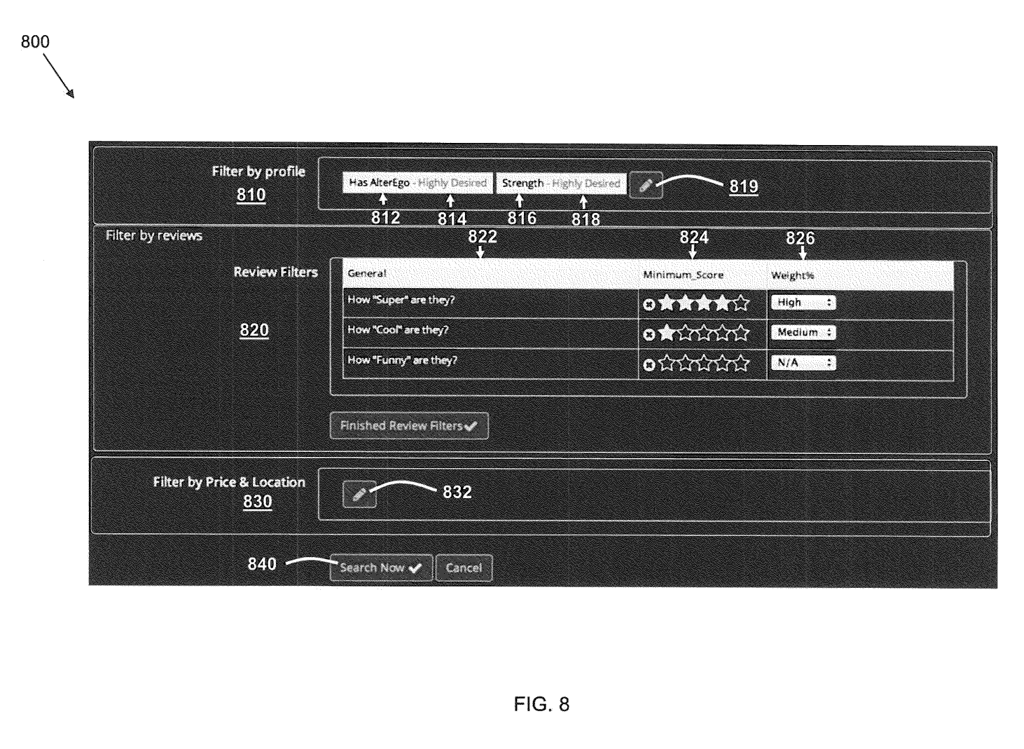

Once goods or services have been catalogued into the database of goods or services, a user, such as another member of the public, may perform a search for goods or services in the database by creating a search query. FIG. 8 illustrates a screenshot 800 of a search query GUI according to an embodiment of the present invention. The search query may include desired parameters 810, a review rating 820, and/or a price/location 830.

Desired parameters 812, 814 are selected by a user from the plurality of parameters entered by the database builder with reference to FIG. 4. As shown in FIG. 8, the desired parameters 812, 814 include “Has AlterEgo” and “Strength” respectively.

In addition, the user may weight each of the desired parameters 812, 814, by specifying a respective parameter weighting 816, 818 to a respective desired parameter 812, 814. The parameter weighting specifies an importance of the desired parameter appearing in search results. The parameter weighting may include a number of parameter weighting levels and the parameter weighting levels may be descriptive, for example ranging from mandatory, highly desired, desired, undesired, excluding and not applicable. In another embodiment, a parameter weighting level may be provided numerically from 5 being mandatory to 0, undesired.

The user may also search according to a review rating 820 provided by other users in response to the review questions configured by the database builder in FIG. 5. For example, for each review question 822, the user may set a minimum rating 824 and a review question weighting 826. Similar to the parameter weighting, the review question weighting may be descriptive or numerical and may include a number of review question weighting levels, from which the user may select.

The user may also search according to a price and/or a location 830 by clicking on a price/location button 832 and entering a location and a price. The price may be a price range, a maximum price and a minimum price, and the location may be a country, a state, a county, a region or any other suitable location. In order to commence the search, the user clicks a search now button 840.

It should be appreciated that the search query may include other factors such as whether trusted reviews are preferred, and an availability of a product or service. As an illustrative example, all reviews by trusted reviewers of a user can be provided on the data interface. As a further example, reviews can be weighted according to the association between the corresponding reviewer and a user, for example whether the reviewer is trusted by the user.

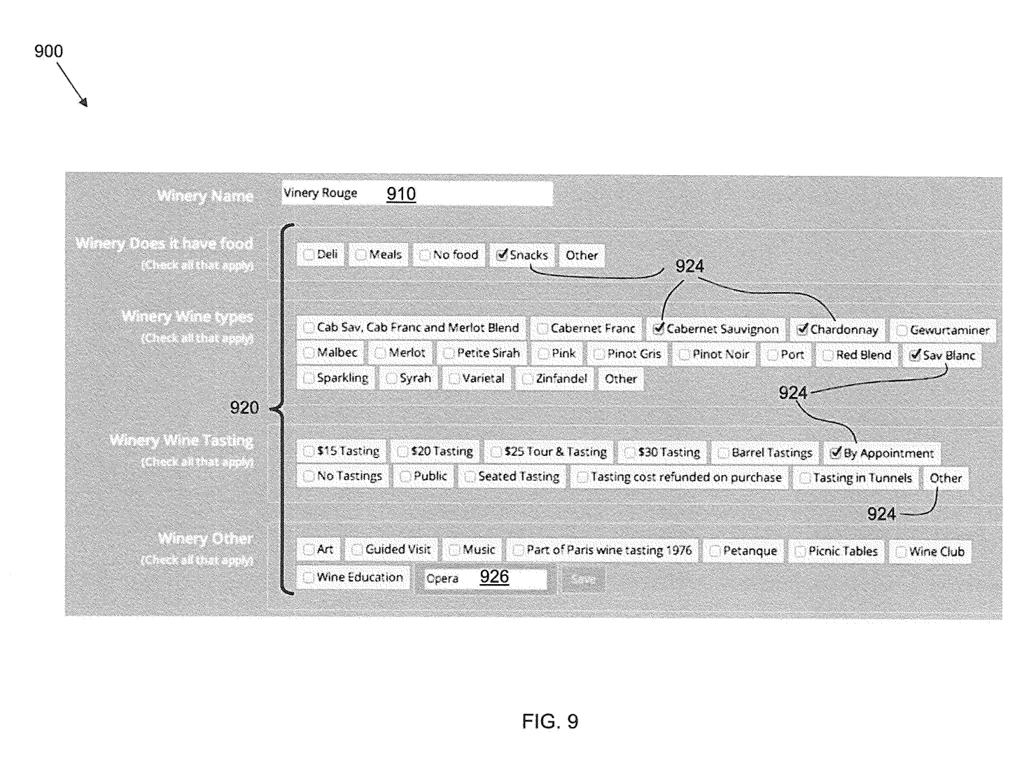

To further describe the present invention, another embodiment is described below in the form of a searchable website that describes wineries. In this case, similar to the superhero embodiment described in relation to FIGS. 3-5, the database builder may define parameters of the searchable database, and set review questions. Once the searchable database has been constructed, a user may catalogue specific wineries. FIG. 9 illustrates a screenshot 900 of a first GUI for cataloguing wineries according to an embodiment of the present invention.

As shown in FIG. 9, and similar to the embodiment of FIG. 7, the user may enter a name 910 of the winery, and identify parameters 922 from a plurality of parameters defined by the database builder. As shown in FIG. 9, parameters 920 are grouped into categories 930 that were entered by the database builder. Similar to FIG. 7, the user may enter other parameters not listed by clicking on an other button 924, and entering a suitable description of a parameter in a text field 926.

Similar to FIG. 7, the user may then provide a rating for each of the review questions entered by the database builder. In addition, it should be appreciated that other users, who are not adding goods or services by cataloguing a new winery, may also provide an independent rating of wineries already in the database.

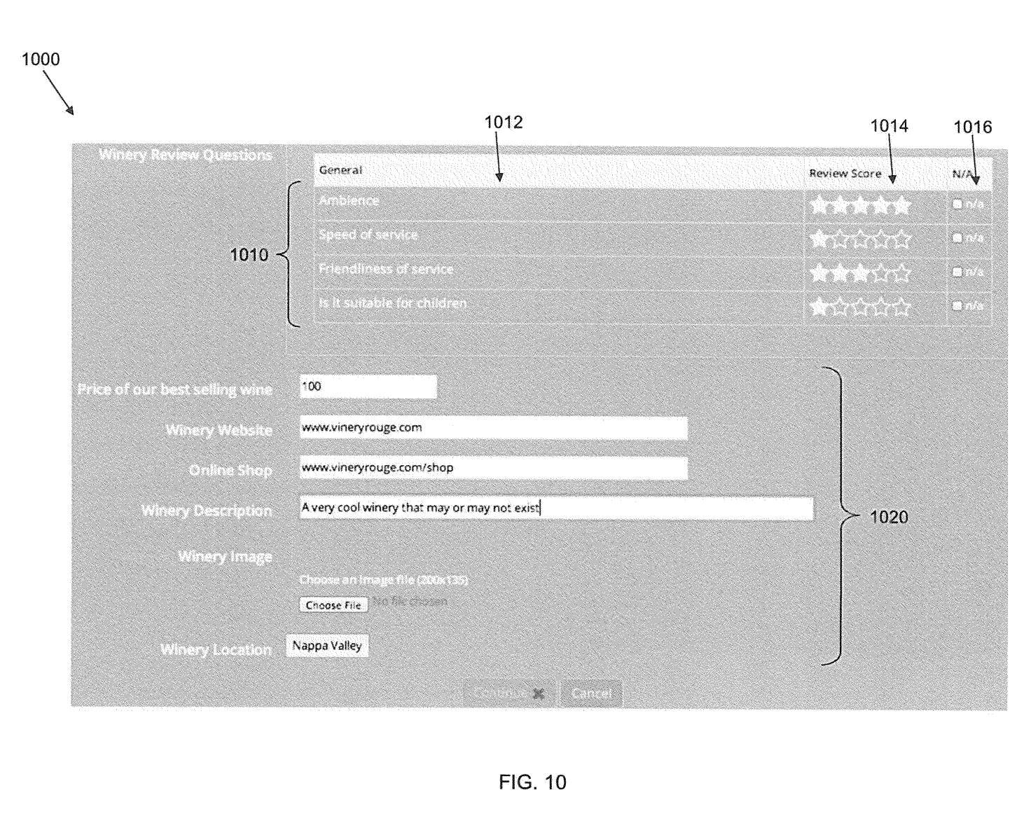

FIG. 10 illustrates a screenshot 1000 of a second GUI for cataloguing wineries according to an embodiment of the present invention. As shown in FIG. 10, a user may provide a rating 1014 for each review question 1012, or if not applicable check a suitable check box 1016. In addition, the user may provide general details 1020 of the winery, such as a price of a best selling wine, a website address, an online shop web address, a brief description of the winery, a winery image, and a winery location, which in this case is a winery region.

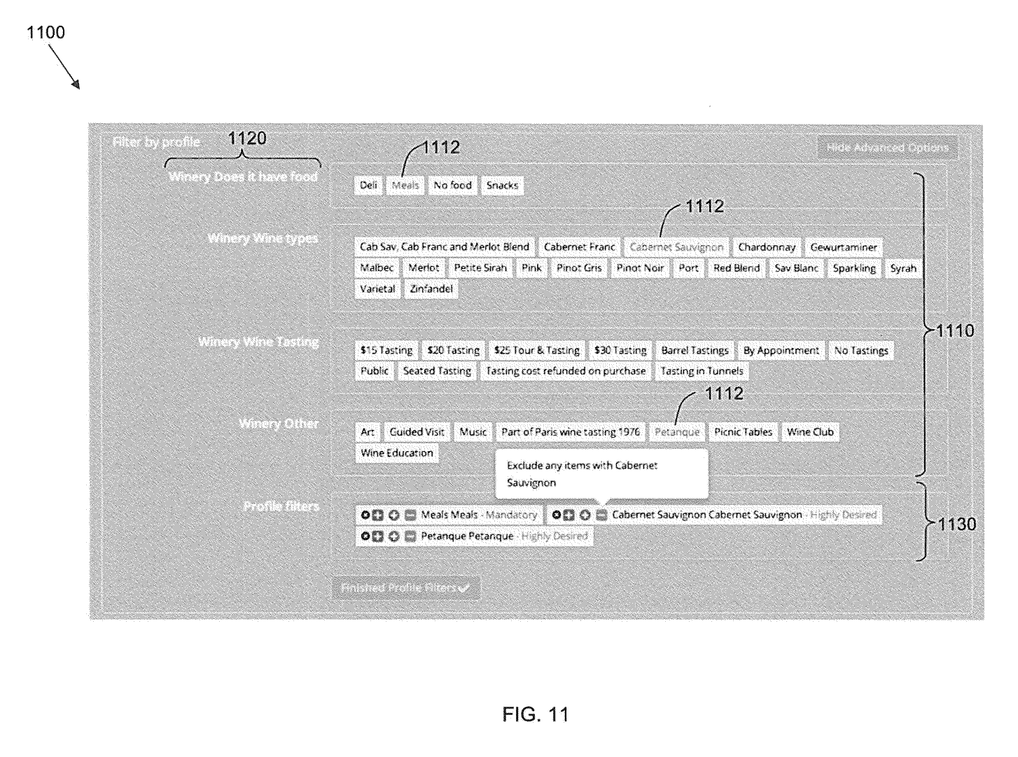

Similar to the embodiment described with reference to FIG. 8, a user may search for wineries according to a search query. The search query may include identified parameters selected from the plurality of parameters defining the goods or services. FIG. 11 illustrates a screenshot 1100 of a first winery search GUI according to an embodiment of the present invention. Similar to the embodiment described with reference to FIG. 8, parameters 1110 are grouped into categories 1120. As shown in FIG. 11 the user may identify desired parameters from a plurality of parameters 1110 defining the goods or services to include in the search query. Each desired parameter 1112 may be highlighted in a different colour, for example, or distinguished in any other suitable manner. As shown in FIG. 11, in this case a user has identified desired parameters of Meals, Cabernet Sauvignon, and Petanque to include in the search query.

The user can also provide a parameter weighting for each desired parameter 1112 by clicking on suitable icons 1130. The parameter weighting may include a positive weighting, for example parameters to be included in any search results, or a negative weighting to exclude parameters from a search. Similar to the embodiment of FIG. 8, the parameter weighting may include a number of parameter weighting levels, and the parameter weighting levels may be descriptive or numerical.

In the embodiment of FIG. 11, the user has positively weighted Meals, Cabernet Sauvignon and Petanque. In particular, the user has specified that a winery that serves meals is mandatory and that it is highly desirable to include wineries in the search that serve/sell/grow Cabernet Sauvignon, and where a user can play Petanque.

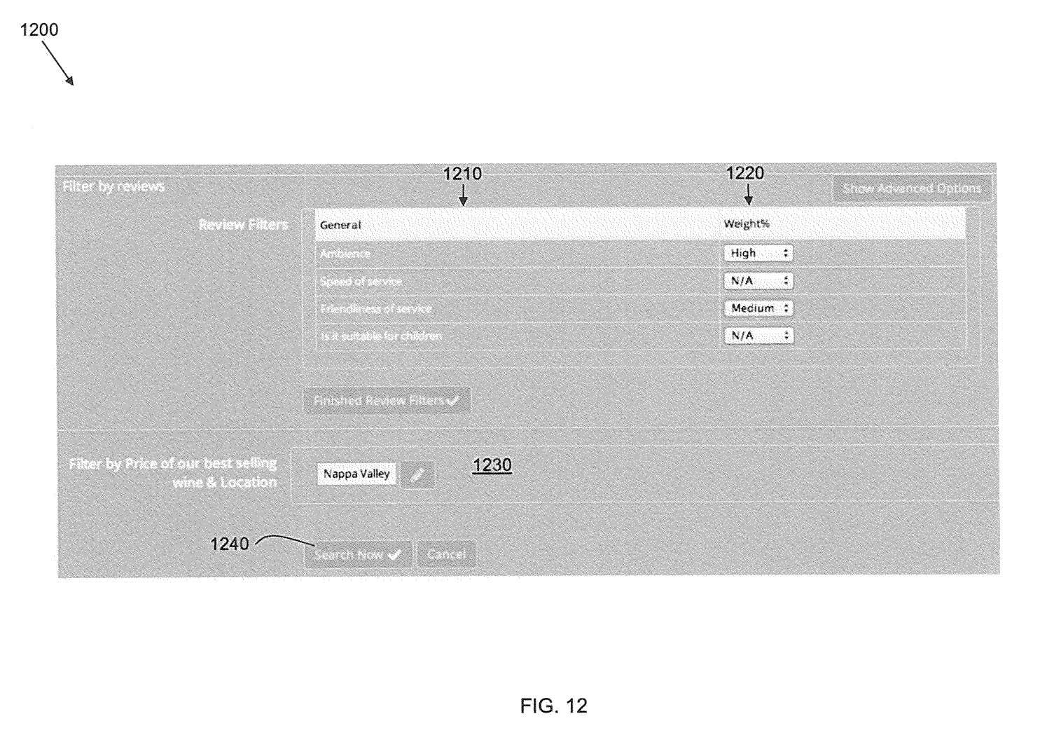

In addition, and similar to the embodiment described in relation to FIG. 8, the search query may be limited according to review ratings provided by other users, and may assign a weighting to each review rating. FIG. 12 illustrates a screenshot 1200 of a second winery search GUI according to an embodiment of the present invention. As shown in FIG. 12, the GUI includes review questions 1210 which were entered by the database builder when constructing the database. For each review question 1210, the user provides a review rating weighting 1220. The review rating weighting 1220 may be descriptive. For example the review rating weighting 1230 may range from high, to medium, to low or not applicable. In other embodiments, the review rating weighting may be numerical. In addition, although not shown, the user may enter a minimum review rating, similar to the minimum rating 824 in FIG. 8.

Similar to the embodiment shown in FIG. 8, the search query may also include a desired price range and/or a location 1230. In the embodiment shown in FIG. 10, the user has only specified a region for Napa Valley wineries. Once the search query has been entered, the user may click on a search now button 1240 to start the search.

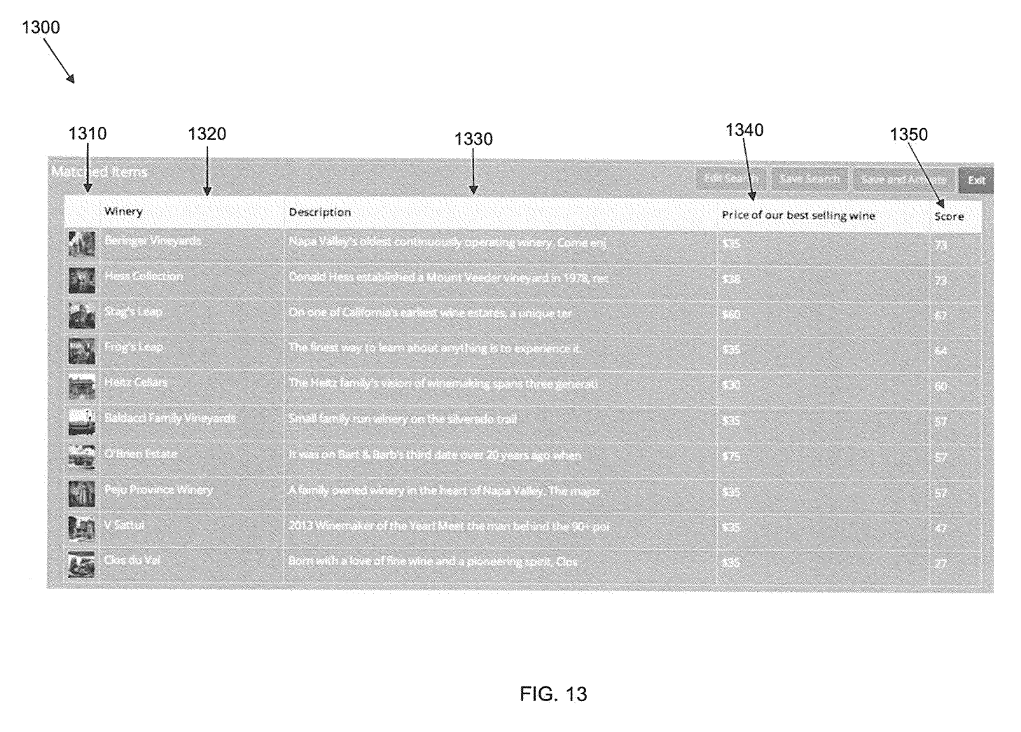

FIG. 13 illustrates a screenshot 1300 of a search result GUI according to an embodiment of the present invention. As shown in FIG. 13, each winery in the search result GUI is listed in a separate row in a table. Columns are arranged according to a thumbnail 1310 of the winery, a name 1320 of the winery, a description 1330 of the winery, a price 1340 of a best selling wine and a search score 1350. However it should be appreciated that the presentation of the results may be in any suitable form, and may be customisable by the user. The search score 1350 indicates a relative match between the desired parameters specified in the search query and the identification of the catalogued goods or services received from the user. In addition, the search score may reflect a relative match according to the review ratings, the price and/or the location. Further the search score may be improved when a trusted relationship exists between the user and a reviewer.

In another embodiment, the search results may be analysed to determine how a search score ranking may be improved, and to provide feedback to users who catalogue goods and services. For example, the feedback may include a percentage of searches where a particular parameter was included in the search results. In addition, the feedback may include a percentage of searches where each parameter or review question meets a search query, a score given to the parameter from a search query, or a score impact of each parameter or review question from all searches performed within a certain time period.

For example, a user may be searching for a winery with parameters of Cabernet Sauvignon, Sauvignon Blanc, serves meals and has picnic tables. A winery may include the parameters Cabernet Sauvignon, Sauvignon Blanc, and serves meals thus a search score may be 75%. In the case the winery could improve its search score by installing picnic tables at the winery. In addition, search results may include a number of users that are searching for a particular parameter, and provide feedback on a number of users requesting a particular parameter. For example, feedback could report that 80% of searchers include the parameter of a picnic table. Thus the feedback may suggest that the winery install picnic tables, as a high number of searchers are including the picnic table parameter in the search query.

In addition, feedback may be provided as a result of review ratings. For example, feedback may be provided to a winery that the search score could be improved by making the restaurant more child-friendly.

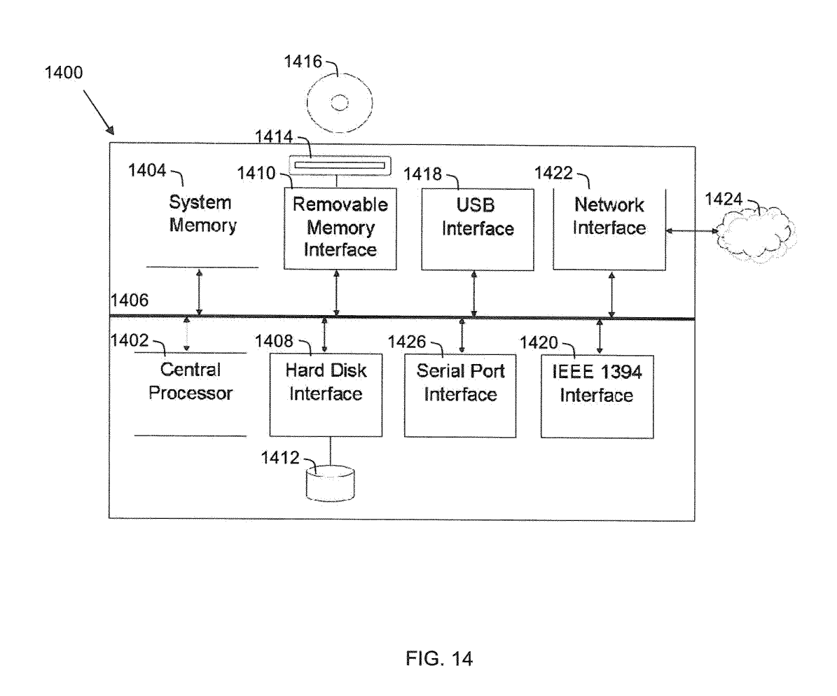

As previously described, the present invention may be implemented using the system 200 of FIG. 2. However it should be appreciated that the present invention may also be performed on a stand-alone computing device such as a personal computer, laptop, tablet or smartphone which is not connected to the Internet. FIG. 14 diagrammatically illustrates a computing device 1400 for performing the method of the present invention, such as the database builder computing device 210, the user computing device and the server 230, according to an embodiment of the present invention. Similarly, the method 100 of FIG. 1 can be implemented using the computing device 1400.

The computing device 1400 includes a central processor 1402, a system memory 1404 and a system bus 1406 that couples various system components, including coupling the system memory 1404 to the central processor 1402. The system bus 1406 may be any of several types of bus structures including a memory bus or memory controller, a peripheral bus, and a local bus using any of a variety of bus architectures. The structure of system memory 1404 is well known to those skilled in the art and may include a basic input/output system (BIOS) stored in a read only memory (ROM) and one or more program modules such as operating systems, application programs and program data stored in random access memory (RAM).

The computing device 1400 can also include a variety of interface units and drives for reading and writing data.

In particular, the computing device 1400 includes a hard disk interface 1408 and a removable memory interface 1410, respectively coupling a hard disk drive 1412 and a removable memory drive 1414 to the system bus 1406. Examples of removable memory drives 1414 include magnetic disk drives and optical disk drives. The drives and their associated computer-readable media, such as a Digital Versatile Disc (DVD) 1416 provide non-volatile storage of computer readable instructions, data structures, program modules and other data for the computer system 1400. A single hard disk drive 1412 and a single removable memory drive 1414 are shown for illustration purposes only and with the understanding that the computing device 1400 can include several similar drives. Furthermore, the computing device 1400 can include drives for interfacing with other types of computer readable media.

The computing device 1400 may include additional interfaces for connecting devices to the system bus 1406. FIG. 14 shows a universal serial bus (USB) interface 1418 which may be used to couple a device to the system bus 1406. For example, an IEEE 1394 interface 1420 may be used to couple additional devices to the computing device 1400.

The computing device 1400 can operate in a networked environment using logical connections to one or more remote computers or other devices, such as a server, a router, a network personal computer, a peer device or other common network node, a wireless telephone or wireless personal digital assistant. The computing device 1400 includes a network interface 1422 that couples the system bus 1406 to a local area network (LAN) 1424. Networking environments are commonplace in offices, enterprise-wide computer networks and home computer systems.

A wide area network (WAN), such as the Internet, can also be accessed by the computing device 1400, for example via a modem unit connected to a serial port interface 1426 or via the LAN 1424. Transmission of data can be performed using the LAN 1424, the WAN, or a combination thereof.

It will be appreciated that the network connections shown and described are exemplary and other ways of establishing a communications link between computers can be used. The existence of any of various well-known protocols, such as TCP/IP, Frame Relay, Ethernet, FTP, HTTP and the like, is presumed, and the computing device 1400 can be operated in a client-server configuration to permit a user to retrieve data from, for example, a web-based server.

The operation of the computing device 1400 can be controlled by a variety of different program modules. Examples of program modules are routines, programs, objects, components, and data structures that perform particular tasks or implement particular abstract data types. The present invention may also be practiced with other computer system configurations, including hand-held devices, multiprocessor systems, microprocessor-based or programmable consumer electronics, network PCs, minicomputers, mainframe computers, personal digital assistants and the like. Furthermore, the invention may also be practiced in distributed computing environments where tasks or individual method steps are performed by one or more remote processing devices that are linked through a communications network. In a distributed computing environment, program modules may be located in both local and remote memory storage devices.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above described invention.

1. A method of constructing a searchable database that catalogues goods or services, the method comprising:
presenting to a database builder a plurality of predefined database features;
receiving from the database builder an identification of selected database features from the plurality of predefined database features;
receiving from the database builder a plurality of parameters defining the goods or services;
generating a search algorithm for searching the goods or services according to the parameters;
generating a graphical user interface that displays the selected database features and the plurality of parameters defining the goods or services;
receiving from a user an identification of catalogued goods or services that are identified using the plurality of parameters;
receiving from a user a search query that identifies desired parameters selected from the plurality of parameters defining the goods or services; and
transmitting search results to a user;
wherein the search results are selected according to the search query and ranked according to a relative match between the desired parameters in the search query, and the identification of the catalogued goods or services.

2. The method of claim 1, wherein each desired parameter is weighted according to a parameter weighting selected from a plurality of parameter weighting levels.

3. The method of claim 1, wherein a first user provides the identification of catalogued goods or services and a second user provides the search query that identifies desired parameters.

4. The method of claim 1, further comprising receiving a plurality of reviews associated with catalogued goods or services, wherein each review in the plurality of reviews is associated with a reviewer and includes an answer to a review question.

5. The method of claim 1, further comprising receiving from the database builder a plurality of questions defining review questions for use in reviewing catalogued goods or services.

6. The method of claim 5, wherein the search results are selected according to a review question rating provided by other users.

7. The method of claim 6, wherein a review question is weighted according to a review question weighting selected from a plurality of review question weightings.

8. The method of claim 7, wherein each review question includes a question, a question hint and a plurality of review rating levels.

9. The method of claim 1, wherein the search results are selected according to the search query and ranked according to a relative match between the desired parameters in the search query, the identification of the catalogued goods or services, and answers to review questions.

10. The method of claim 1, wherein the search results are selected according to a location.

11. The method of claim 1, wherein the search results are selected according to a price.

12. The method of claim 1, wherein the parameters are grouped according to one or more categories.

13. The method of claim 1, wherein the search results are analysed to determine which parameters would increase a rank of particular goods or services listed in the search results.

14. A system for constructing a searchable database that catalogues goods or services, the system including a computing device, the computing device including a processor coupled to a memory, the memory including program code components configured to cause the processor to:
present to a database builder a plurality of predefined database features;
receive from the database builder an identification of selected database features from the plurality of predefined database features;
receive from the database builder a plurality of parameters defining the goods or services;
generate a search algorithm for searching the goods or services according to the parameters;
generate a graphical user interface that displays the selected database features and the plurality of parameters defining the goods or services;
receive from a user an identification of catalogued goods or services that are identified using the plurality of parameters;
receive from a user a search query that identifies desired parameters selected from the plurality of parameters defining the goods or services; and
transmit search results to a user;
wherein the search results are selected according to the search query and ranked according to a relative match between the desired parameters in the search query, and the identification of the catalogued goods or services.
